(19) United States
(12) Patent Application Publication
(10) Pub. No.: US 2024/0270011 A1
(43) Pub. Date: Aug. 15, 2024

(54) BICYCLE WHEEL ASSEMBLY STRUCTURE

(71) Applicant: HEXA CO., LTD., Taipei City (TW)

(72) Inventor: Mark Chen, Taipei City (TW)

(21) Appl. No.: 18/107,511

(22) Filed: Feb. 9, 2023

(51) Int. Cl. B60B 1/04; B60B 21/06

(52) U.S. Cl. CPC B60B 1/045; B60B 1/041; B60B 1/042; B60B 21/062

(57) ABSTRACT

A bicycle wheel assembly structure includes an annular rim, a hub, nipples, and spokes. The annular rim includes rim penetration sections, each of which includes a rim-side limiting part. The hub is arranged at a center of the annular rim and includes hub penetration sections. The nipples each include a thread-connecting section and a nipple limiting part. The nipples are arranged on the rim penetration sections, and the nipple limiting parts are mounted to the rim-side limiting parts. The spokes include an intermediate section, a head section, and a thread section. The head sections are mounted to the hub penetration sections. The thread sections are connected to the thread-connecting sections of the nipples. The spokes, when set between the annular rim and the hub, induce tensions that cooperate with static frictional forces at the rim-side limiting parts and the nipple limiting parts resist sliding and prevent loosening of the spokes.

### TECHNICAL FIELD OF THE INVENTION

The present invention relates generally to improvement and innovation of a bicycle wheel assembly structure, and more particularly to a bicycle wheel assembly that has excellent stability and a simplified structure, and is capable of reducing an assembling cost.

### DESCRIPTION OF THE PRIOR ART

A known anti-loosening solution for bicycle spokes is increasing a resisting force between an external thread of a spoke and an internal thread of a nipple in order to reduce relative sliding between the spoke and the nipple.

It is often that a nylon insert is added between the spoke and the nipple to resist sliding, or an adhesive is applied to secure the spoke and the nipple, or the shapes of the external thread of the spoke and the internal thread of the nipple are modified to prevent loosening.

However, a nylon insert has only a limited effect of resisting sliding, and requires additional materials and the cost for applying. Securing with adhesive would make it impossible for subsequent fine adjustment. Modifying the shapes of the external thread of the spoke and the internal thread of the nipple may result in difficulty of assembling and may not meet the specification requirements.

### SUMMARY OF THE INVENTION

The primary objective of the present invention is that when spokes are set between an annular rim and a hub, tensions of the spokes cooperate with static frictional forces generated at rim-side limiting parts and nipple limiting parts resist sliding and to prevent loosening of the spokes.

To achieve the above objective, the present invention provides an improvement on a bicycle wheel assembly structure, which comprises: an annular rim, a hub, multiple nipples, and multiple spokes. The annular rim is provided with multiple rim penetration sections, and each of the rim penetration sections is provided, at an edge thereof, with a rim-side limiting part. The hub is arranged at a center of the annular rim, and the hub is provided with multiple hub penetration sections. Each of the nipples is provided, in an inside thereof, with a thread-connecting section, and each of the nipples is provided, on an outside thereof, with a nipple limiting part. The nipples are respectively arranged on the rim penetration sections of the annular rim, and the nipple limiting parts of the nipples are respectively mounted to the rim-side limiting parts. Each of the spokes comprises an intermediate section, a head section, and a thread section. The head section is arranged at one end the intermediate section, and the thread section is arranged at an opposite end of the intermediate section. The head sections of the spokes are respectively mounted to the hub penetration sections. The thread sections of the spokes are respectively connected to the thread-connecting sections of the nipples.

In an embodiment of the above bicycle wheel assembly, each of the rim-side limiting parts is formed as an internal hexagonal pyramid, and each of the nipple limiting parts is formed as an external hexagonal pyramid, so that the nipple limiting part and the rim-side limiting part, after being mounted, limit and constrain each other in position.

In an embodiment of the above bicycle wheel assembly, each of the hub penetration sections has an internal circumference along which a hub-side limiting part is formed, and each of the head sections has an external circumference along which a spoke limiting part is formed, wherein the head section of each of the spokes is mounted by means of the spoke limiting part, to each of the hub penetration sections.

In an embodiment of the above bicycle wheel assembly, each of the hub-side limiting parts is formed as an internal hexagonal pyramid, and each of the spoke limiting parts is formed as an external hexagonal pyramid, so that the spoke limiting part and the hub-side limiting part, after being mounted, limit and constrain each other in position.

In an embodiment of the above bicycle wheel assembly, for each of the spokes, the intermediate section, the head section, and the thread section are integrally formed together as a one piece structure, and are arranged at a common location in a longitudinal direction so that each of the spokes shows a linear configuration.

In an embodiment of the above bicycle wheel assembly, each of the spokes comprises a bend section between the intermediate section and the head section, and the intermediate section, the head section, the thread section, and the bend section are integrally formed together as a one piece structure, and the intermediate section and the thread section are arranged at a common location in a longitudinal direction, while the head section and the bend section rearranged at a common location in a transverse direction, so that each of the spokes shows an end-curved configuration.

### BRIEF DESCRIPTION OF THE DRAWINGS

FIG. 1 is a first schematic view showing an arrangement of a nipple and a spoke according to the present invention.

FIG. 2 is a second schematic view showing an arrangement of a nipple and a spoke according to the present invention.

FIG. 3 is a schematic view showing a state of use of the present invention.

### DETAILED DESCRIPTION OF THE PREFERRED EMBODIMENT

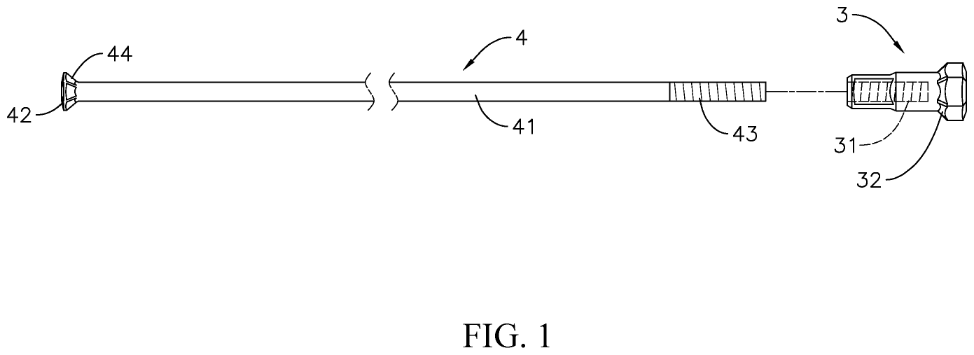

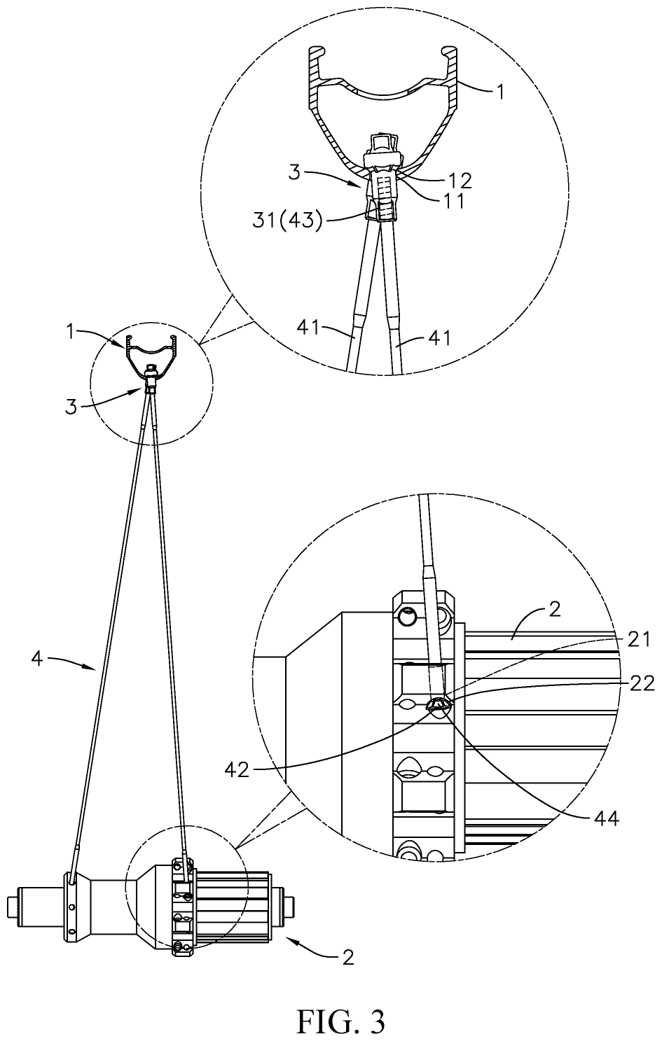

Referring to FIGS. 1-3, which are respectively a first schematic view showing an arrangement of a nipple and a spoke according to the present invention, a second schematic view showing an arrangement of a nipple and a spoke according to the present invention, and a schematic view showing a state of use of the present invention, as shown in the drawings, the present invention discloses a bicycle wheel assembly structure, which at least comprises an annular rim 1, a hub 2, multiple nipples 3, and multiple spokes 4.

The annular rim 1 is provided with multiple rim penetration sections 11, and each of the rim penetration sections 11 is provided, at an edge thereof, with a rim-side limiting part 12.

The hub 2 is arranged at a center of the annular rim 1, and the hub 2 is provided with multiple hub penetration sections 21.

Each of the nipples 3 is provided, in an inside thereof, with a thread-connecting section 31, and each of the nipples 3 is provided, on an outside thereof, with a nipple limiting part 32. The nipples 3 are arranged on the rim penetration sections 11 of the annular rim 1, and the nipple limiting part 32 of the nipples 3 are respectively mounted to the rim-side limiting parts 12.

Each of the spokes 4 comprises an intermediate section 41, a head section 42, and a thread section 43. The head section 42 is arranged at one end of the intermediate section 41, and the thread section 43 is arranged at an opposite end of the intermediate section 41. The head sections 42 of the spokes 4 are respectively mounted to the hub penetration sections 21, and the thread sections 43 of the spokes 4 are respectively connected to the thread-connecting sections 31 of the nipples 3.

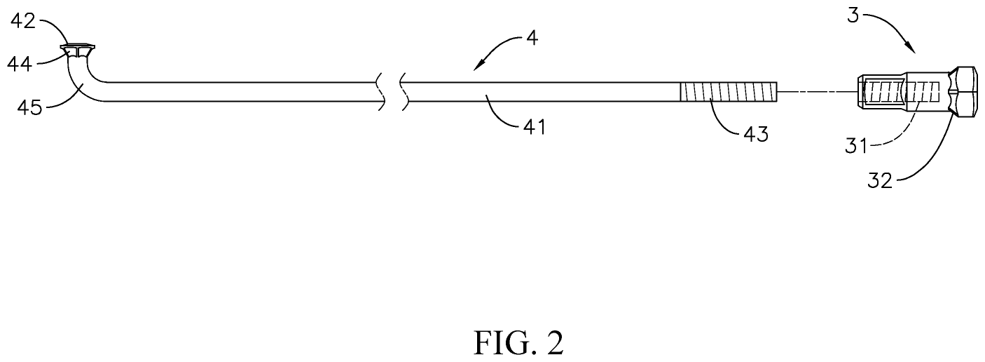

In one embodiment of the present invention, for each of the spokes 4, the intermediate section 41, the head section 42, and the thread section 43 are integrally formed together as a one piece structure and are arranged at a common location in a longitudinal direction so that each of the spokes 4 is structured with a linear configuration (as shown in FIG. 1). Alternatively, each of the spokes 4 comprises a bend section 45 between the intermediate section 41 and the head section 42, and the intermediate section 41, the head section 42, the thread section 43, and the bend section 45 are integrally formed together as a one piece structure, and the intermediate section 41 and the thread section 43 are arranged at a common location in a longitudinal direction, while the head section 42 and the bend section 45 are arranged at a common location in a transverse direction, so that each of the spokes 4 shows an end-curved configuration (as shown in FIG. 2).

To assemble the present invention, the nipples 3 are respectively set in the rim penetration sections 11 of the annular rim 1, such that the nipple limiting parts 32 of the nipples 3 are respectively mounted to the rim-side limiting parts 12; and, the head sections 42 of the spokes 4 (for both the linear configuration and the end-curved configuration of the spokes 4) are respectively set in the hub penetration sections 21, and the thread sections 43 of the spokes 4 are respectively screwed into engagement with the thread-connecting sections 31 of the nipples 3, so as to have each of the spokes 4 set up between the annular rim 1 and the hub 2 by means of natural ways of coupling, without the need for additionally applying a nylon insert or adhesives or modifying the shape of each of the spokes 4, wherein the tension of each of the spokes 4 cooperates with a static frictional force generated at the rim-side limiting part 12 and the nipple limiting parts 32 to resist sliding of the spoke 4 and present loosening thereof.

In one embodiment of the present invention, each of the rim-side limiting parts 12 is structured as an internal hexagonal pyramid (or polygonal pyramid), and each of the nipple limiting parts 32 is structured as an external hexagonal pyramid (or polygonal pyramid), so that each of the nipple limiting parts 32 and a respective one of the rim-side limiting parts 12, after being combined with each other, demonstrate an effect of limiting and constraining each other in position. As such, by means of the multiple-angled configuration of each of the rim-side limiting parts 12 and each of the nipple limiting parts 32, when the spokes 4 are set up between the annular rim 1 and the hub 2, the tension of each of the spokes 4 cooperates with a static frictional force generated at each of the rim-side limiting parts 12 and a respective one of the nipple limiting parts 32 to resist sliding of the spokes 4 and also prevent loosening thereof.

In one embodiment of the present invention, each of the hub penetration sections 21 has an internal circumference along which a hub-side limiting part 22 is formed, and each of the head sections 42 has an external circumference along which a spoke limiting part 44 is formed, wherein the hub-side limiting part 22 is structured as an internal hexagonal pyramid (or polygonal pyramid), and each of the spoke limiting parts 44 is structured as an external hexagonal pyramid (or polygonal pyramid), and the spoke limiting parts 44 of the head sections 42 of the spokes 4 are respectively mounted to the hub penetration sections 21, so that each of the spoke limiting parts 44 and a respective one of the hub-side limiting parts 22, after being combined with each other, demonstrate an effect of limiting and constraining each other in position. As such, by means of the multiple-angled configuration of each of the rim-side limiting parts 12, each of the hub-side limiting parts 22, each of the nipple limiting parts 32, and each of the spoke limiting parts 44, when the spokes 4 are set up between the annular rim 1 and the hub 2, the tension of each of the spokes 4 cooperates with a static frictional force induced at the rim-side limiting part 12 and the hub-side limiting part 22, and the nipple limiting part 32 and the spoke limiting part 44 to resist sliding of the spokes 4 and also prevent loosening thereof.

In summary, the present invention provides a bicycle wheel assembly structure that effectively overcomes the defects of the prior art in such a way that when the spokes are set up between the annular rim and the hub, tensions of the spokes cooperate static frictional forces induced at the rim-side limiting parts and the nipple limiting parts to resist sliding of the spokes and also prevent loosening thereof.

I claim:

1. A bicycle wheel assembly structure, comprising:
an annular rim, which is provided with multiple rim penetration sections, each of the rim penetration sections being provided, at an edge thereof, with a rim-side limiting part;
a hub, which is arranged at a center of the annular rim, the hub being provided with multiple hub penetration sections;
multiple nipples, each of the nipples being provided, in an inside thereof, with a thread-connecting section, each of the nipples being provided, on an outside thereof, with a nipple limiting part, the nipples being respectively arranged on the rim penetration sections of the annular rim, the nipple limiting parts of the nipples being respectively mounted to the rim-side limiting parts; and
multiple spokes, each of which comprises an intermediate section, a head section, and a thread section, the head section being arranged at one end the intermediate section, the thread section being arranged at an opposite end of the intermediate section, the head sections of the spokes being respectively mounted to the hub penetration sections, the thread sections of the spokes being respectively connected to the thread-connecting sections of the nipples.

2. The bicycle wheel assembly structure according to claim 1, wherein each of the rim-side limiting parts is formed as an internal hexagonal pyramid, and each of the nipple limiting parts is formed as an external hexagonal pyramid, so that the nipple limiting part and the rim-side limiting part, after being mounted, limit and constrain each other in position.

3. The bicycle wheel assembly structure according to claim 1, wherein each of the hub penetration sections has an internal circumference along which a hub-side limiting part is formed, and each of the head sections has an external circumference along which a spoke limiting part is formed, wherein the head section of each of the spokes is mounted by means of the spoke limiting part, to each of the hub penetration sections.

4. The bicycle wheel assembly structure according to claim 3, wherein each of the hub-side limiting parts is formed as an internal hexagonal pyramid, and each of the spoke limiting parts is formed as an external hexagonal pyramid, so that the spoke limiting part and the hub-side limiting part, after being mounted, limit and constrain each other in position.

5. The bicycle wheel assembly structure according to claim 1, wherein for each of the spokes, the intermediate section, the head section, and the thread section are integrally formed together as a one piece structure, and are arranged at a common location in a longitudinal direction so that each of the spokes shows a linear configuration.

6. The bicycle wheel assembly structure according to claim 1, wherein each of the spokes comprises a bend section between the intermediate section and the head section, and the intermediate section, the head section, the thread section, and the bend section are integrally formed together as a one piece structure, and the intermediate section and the thread section are arranged at a common location in a longitudinal direction, while the head section and the bend section re arranged at a common location in a transverse direction, so that each of the spokes shows an end-curved configuration.
